(19) United States
(12) Patent Application Publication
(10) Pub. No.: US 2013/0272780 A1
(43) Pub. Date: Oct. 17, 2013

(54) Joint Member and Method for Producing the Same, and Method for Producing Metal Composite Molded Product

(71) Applicant: Teijin Limited, Osaka (JP)

(72) Inventors: Masaki Takeuchi, Gotemba-shi (JP); Toru Kaneko, Gotemba-shi (JP); Masumi Hirata, Gotemba-shi (JP); Takumi Kato, Gotemba-shi (JP); Hiroki Sano, Gotemba-shi (JP)

(21) Appl. No.: 13/904,107

(22) Filed: May 29, 2013

Related U.S. Application Data
(63) Continuation-in-part of application No. PCT/JP2011/077886, filed on Nov. 25, 2011.

(30) Foreign Application Priority Data
Nov. 30, 2010 (JP) 2010-266544
May 29, 2012 (JP) 2012-122121
May 29, 2012 (JP) 2012-122123

(51) Int. Cl. C09J 5/06

(52) U.S. Cl. CPC C09J 5/06
USPC 403/270; 156/327; 156/272.2

(57) ABSTRACT

A method for producing a joint member between a carbon fiber composite material containing a thermoplastic resin as a matrix and a metal, includes: forming a layer containing a triazine thiol derivative on a surface of the metal; providing a thermoplastic resin layer between the layer containing a triazine thiol derivative and the carbon fiber composite material; and melting the thermoplastic resin layer to join the metal to the carbon fiber composite material.

This application is a continuation-in-part of International Application No. PCT/JP2011/077886 filed on Nov. 25, 2011, which claims priority under 35 U.S.C. §119 from Japanese Patent Application No. 2010-266544 filed on Nov. 30, 2010. This application also claims priority under 35 U.S.C. §119 from Japanese Patent Application Nos. 2012-122121 and 2012-122123, both filed on May 29, 2012. The entire disclosures of the above-mentioned applications are incorporated herein by reference.

### BACKGROUND

1. Technical Field

The present invention relates to a joint member between a carbon fiber composite material and a metal, a method for producing the same and a method for producing a metal composite molded product.

2. Background Art

A carbon fiber composite material has high specific strength and specific rigidity and is valued as an extremely excellent material. However, in joining a conventional carbon fiber composite material using a thermosetting resin as a matrix to a different kind of a member, particularly a metal, those are jointed using bolt/nut, a rivet or the like that are mechanical joints, or an adhesive. The mechanical joint by bolt/nut or the like generally involves increase in weight. Particularly, there is a concern that in a composite material, stress concentrates in a joint point, and in the worst case fracture continuously proceeds starting from the first stress concentrated point. In the joint using an adhesive, an adhesive layer having a certain thickness must be generally secured in order to secure strength. Particularly, in the case of joining a large-sized member, a considerably amount of the adhesive is required. As a result, there is a concern in great increase in weight of the member obtained, and additionally, there is a defect that its strength is not always sufficient with only the adhesive. Furthermore, because much time is required until the adhesive develops generally practical strength, an aging step must be taken into consideration. On the other hand, in a carbon fiber composite material using a thermoplastic resin as a matrix (hereinafter sometimes referred to as a “thermoplastic carbon fiber composite material”), materials are joined to each other by welding in a range that resins are compatible, and joint strength comparable to the matrix resin can be expected. However, there are many cases that the joint to a metal by welding is difficult even in the thermoplastic carbon fiber composite material.

To weld the thermoplastic carbon fiber composite material to a metal, it is required that the thermoplastic resin itself used as a matrix can weld to a metal. Patent Document 1 describes that the reason that a metal and a resin can be joined by welding is due to an anchor effect by injection-molding a resin to an aluminum material having finely porous surface. Patent Documents 2 to 4 describe that a resin and a metal are joined by applying a certain treatment to a metal surface.

Furthermore, Patent Document 5 describes a joining method by providing an intermediate resin layer having an affinity with both a thermosetting carbon fiber composite material and a metal.

The advantage of a thermoplastic carbon fiber composite material is that its shape easily changes by applying heat, and due to this, injection- or press-molding can be conducted in an extremely short period of time as compared with a thermosetting carbon fiber composite material. Therefore, if a carbon fiber composite material containing a thermoplastic resin as a matrix is used and the joint can be extremely easily performed by thermocompression bonding in a mold simultaneously with the molding or just after the molding, a joint body with a metal material can be obtained extremely efficiently. However, even though the thermoplastic carbon fiber composite material is tried to join to a metal by the joining method of a thermoplastic resin and a metal as described in Patent Documents 2 to 4, the thermoplastic carbon fiber composite material is that a thermoplastic resin is in a state of “soaking into” a carbon fiber bundle. Thus, the resin is not always homogeneously present on the surface of the material, and in some cases, a “deficient” portion of a resin is present. Therefore, there was a concern that sufficient joint strength is not developed and joint strength shows great variations. Furthermore, the carbon fiber causes a so-called electrolytic corrosion to a metal. Therefore, when the carbon fiber has been brought into contact with a metal in a portion where the resin has been deficient, the contact has caused the corrosion of a metal. Furthermore, in the thermoplastic carbon fiber composite material, because carbon fibers are contained in the composite material, the presence of unevenness on the surface of the composite material is not avoided. Therefore, it was difficult in conventional methods to strongly join the thermoplastic carbon fiber composite material to the surface of a metal.
Patent Document 1: JP-A-2003-103563
Patent Document 2: JP-B-5-51671
Patent Document 3: WO2009/157445 pamphlet
Patent Document 4: JP-A-2011-235570
Patent Document 5: JP-A-2006-297927

### SUMMARY

An object of the present invention is to provide a method for producing a joint member between a carbon fiber composite material containing a resin as a matrix and a metal, and particularly to provide a method for producing a joint member between a carbon fiber composite material containing a thermoplastic resin as a matrix and a metal, characterized in that joint and molding can be conducted simultaneously.

As a result of intensive investigations on the joint between a thermoplastic carbon fiber composite material and a metal, the present inventors have found that the metal and the thermoplastic carbon fiber composite material can be joined strongly and stably by forming a layer containing a triazine thiol derivative on the surface of the metal, providing a thermoplastic resin layer between the layer containing the triazine thiol derivative and the thermoplastic carbon fiber composite material, and melting the thermoplastic resin layer, thereby joining the metal to the carbon fiber composite material, and have reached the present invention. The constitution of the present invention is described below.

1. A method for producing a joint member between a carbon fiber composite material containing a thermoplastic resin as a matrix and a metal, the method comprising forming a layer containing a triazine thiol derivative on a surface of the metal, providing a thermoplastic resin layer between the layer containing the triazine thiol derivative and the carbon fiber composite material, and melting the thermoplastic resin layer to join the metal to the carbon fiber composite material.
2. The method for producing a joint member as described in item 1 above, wherein the metal is heated by means of electromagnetic induction to perform the melting of the thermoplastic resin layer.
3. The method for producing a joint member as described in any one of items 1 to 2 above, wherein the thermoplastic resin layer has a thickness of from 5 μm to 5 mm.
4. The method for producing a joint member as described in any one of items 1 to 3 above, wherein an element constituting the metal mainly comprises iron or aluminum.
5. The method for producing a joint member as described in any one of items 1 to 4 above, wherein an amount of the thermoplastic resin present in the carbon fiber composite material is from 50 to 1,000 parts by weight per 100 parts by weight of the carbon fiber.
6. The method for producing a joint member as described in any one of items 1 to 5 above, wherein in the providing of the thermoplastic resin layer between the layer containing the triazine thiol derivative and the carbon fiber composite material, the thermoplastic resin layer is provided on the layer containing the triazine thiol derivative formed on the surface of the metal.
7. The method for producing a joint member as described in any one of items 1 to 6 above, wherein the thermoplastic resin constituting the carbon fiber composite material is at least one selected from the group consisting of polyamide, polyester, polypropylene, polycarbonate and polyphenylene sulfide.
8. The method for producing a joint member as described in any one of items 1 to 7 above, wherein the thermoplastic resin layer is formed from a non-woven fabric comprising a thermoplastic resin.
9. The method for producing a joint member as described in any one of items 1 to 4 and 6 to 8 above, wherein a carbon fiber in the carbon fiber composite material has an average fiber length of from 3 to 100 mm, and an amount of the thermoplastic resin present in the carbon fiber composite material is from 50 to 1,000 parts by weight per 100 parts by weight of the carbon fiber.
10. The method for producing a joint member as described in any one of items 1 to 9 above, wherein the carbon fiber composite material comprises a chopped strand mat of carbon fibers and a thermoplastic resin, and

wherein the chopped strand mat comprises a carbon fiber bundle (A) in a ratio of 20 Vol % or more and less than 99 Vol % to a total volume of the carbon fibers, the carbon fiber bundle (A) includes carbon fibers of a critical single fiber number defined by formula (a) or more, and an average number (N) of the carbon fibers in the carbon fiber bundle (A) satisfies formula (b):

Critical single fiber number=600/D (a)

0.7×10⁴/D²<N<1×10⁵/D² (b)

wherein D is an average fiber diameter (μm) of the carbon fibers.
11. The method for producing a joint member as described in any one of items 1 to 10 above, wherein a thermoplastic resin constituting the thermoplastic resin layer is the same kind of resin as the thermoplastic resin constituting the carbon fiber composite material.
12. A joint member comprising a thermoplastic carbon fiber composite material and a metal that are joined in joint strength of 5 MPa or more, obtained by the production method of any one of items 1 to 11 above.
13. A joint member comprising: a carbon fiber composite material; a molten thermoplastic resin layer; a layer containing a triazine thiol derivative; and a metal, wherein the carbon fiber composite material containing a thermoplastic resin as a matrix, and the carbon fiber composite material and the metal are joined by the molten thermoplastic resin layer in joint strength of 5 MPa or more.
14. A method for producing a metal composite molded body comprising a carbon fiber composite material containing a thermoplastic resin as a matrix and a metal, that are joined, the method comprising:

forming a layer containing a triazine thiol derivative on the surface of the metal;

providing a thermoplastic resin layer between the layer containing the triazine thiol derivative and the carbon fiber composite material; and

melting the thermoplastic layer to joint between the metal and the carbon fiber composite material and simultaneously or continuously mold a metal composite molded body into a predetermined form.

According to the present invention, a thermoplastic carbon fiber composite material and a metal can be joined strongly and stably by a simplified method. Furthermore, by joining the thermoplastic carbon fiber composite material to the metal through a thermoplastic resin layer, electrolytic corrosion caused by carbon fiber can be simultaneously prevented. Additionally, a joint member between the carbon fiber composite material and the metal can be obtained in a short period of time and in less number of steps by simultaneously or continuously conducting joint and molding steps.

### BRIEF DESCRIPTION OF THE DRAWINGS

FIG. 1 is a schematic cross-sectional view showing one embodiment of the joint member of the present invention.

FIG. 2 is a schematic view showing the shape of the molded body of the thermoplastic carbon fiber composite material used in Example 5.

FIG. 3 is a schematic view showing the shape of the metal composite molded body obtained in Example 5. In the drawing, a circular SPCC sheet was shown by an oblique line.

### DESCRIPTION OF REFERENCE NUMERALS IN THE DRAWINGS

1 Thermoplastic carbon fiber composite material
2 Thermoplastic resin layer
3 Layer containing a triazine thiol derivative
4 Metal

### DETAILED DESCRIPTION

The present invention relates to a method for producing a joint member between a carbon fiber composite material containing a thermoplastic resin as a matrix and a metal. Embodiments of the present invention are described below.

### [Thermoplastic Carbon Fiber Composite Material]

The thermoplastic carbon fiber composite material used in the present invention is a material containing a thermoplastic resin as a matrix, and a carbon fiber. The thermoplastic carbon fiber composite material preferably contains the thermoplastic resin in an amount of from 50 to 1,000 parts by weight per 100 parts by weight of the carbon fiber. More preferably, the amount of the thermoplastic resin is from 50 to 400 parts by weight per 100 parts by weight of the carbon fiber. Still more preferably, the amount of the thermoplastic resin is from 50 to 100 parts by weight per 100 parts by weight of the carbon fiber. Where the amount of the thermoplastic resin is less than 50 parts by weight per 100 parts by weight of the carbon fiber, dry carbon fiber exposed from the thermoplastic resin of the matrix in the thermoplastic carbon fiber composite material may be increased. On the other hand, where the amount exceeds 1,000 parts by weight, the amount of the carbon fiber is too small, and the carbon fiber may become inappropriate as a reinforcing structural material.

Examples of the thermoplastic resin include polyamide, polycarbonate, polyoxymethylene, polyphenylene sulfide, polyphenylene ether, modified polyphenylene ether, polyester, such as polyethylene terephthalate, polybutylene terephthalate, polyethylene naphthalate, polyolefin such as polyethylene, polypropylene, polystyrene, polymethyl methacrylate, AS resin and ABS resin. Particularly, from the balance between costs and properties, at least one selected from the group consisting of polyamide, polyester, polypropylene, polycarbonate and polyphenylene sulfide is preferred.

As the polyamide (sometimes abbreviated as PA, and sometimes called nylon), at least one selected from the group consisting of PA6 (called polycaproamide or polycaprolactam, and more accurately, poly 8-caprolactam), PA26 (polyethylene adipamide), PA46 (polytetramethylene adipamide), PA66 (polyhexamethylene adipamide), PA69 (polyhexamethylene azepamide), PA610 (polyhexamethylene sebacamide), PA611 (polyhexamethylene undecamide), PA612 (polyhexamethylene dodecamide), PA11 (polyundecane amide), PA12 (polydodecane amide), PA1212 (polydodecamethylene dodecamide), PA6T (polyhexamethylene terephthalamide), PA6I (polyhexamethylene isophthalamide), PA912 (polynonamethylene dodecamide), PA1012 (polydecamethylene dodecamide), PA9T (polynonamethylene terephthalamide), PA9I (polynonamethylene isophthalamide), PA10T (polydecamethylene terephthalamide), PA10I (polydecamethylene isophthalamide), PA11T (polyundecamethylene terephthalamide), PA11I (polyundecamethylene isophthalamide), PA12T (polydodecamethylene terephtalamide), PA12I (polydodecamethylene isophthalamide) and polyamide MXD6 (polymetaxylene adipamide) is preferred. Those thermoplastic resins may contain additives such as a stabilizing agent, a flame retardant, a pigment and a filler, according to the need.

The form of the carbon fiber in the thermoplastic carbon fiber composite material is not particularly limited, and the carbon fiber can be a continuous fiber or a discontinuous fiber. In the case of the continuous fiber, the carbon fiber may be in the form of a woven fabric, and may be in the form of a non-woven sheet in which carbon fibers are arranged in one direction (so-called “UD sheet”). In this case, the fiber layers are stacked in a multilayer by changing the fiber arrangement direction of each layer. For example, the layers can be alternately stacked in directions perpendicular to each other. A preferable diameter of the continuous fiber is from 5 to 20 μm.

In the case of discontinuous carbon fibers, the carbon fibers may be dispersed and arranged so as to overlap in the thermoplastic carbon fiber composite material. In this case, an average fiber length is preferably from 3 to 100 mm, more preferably from 5 to 100 mm, and particularly preferably from 10 to 50 mm. When the average fiber length of the carbon fibers is 3 mm or more, thermal shrinkage of the thermoplastic carbon fiber composite material after joint is small. When the average fiber length is 100 mm or less, the proportion of carbon fibers exposed to the surface of the thermoplastic carbon fiber composite material is small, contact area to a metal can be sufficiently secured, and sufficient joint strength can be achieved. In the case of the discontinuous carbon fibers, the carbon fibers may be present in the state of carbon fiber bundle in which many single fibers are bundled in the thermoplastic carbon fiber composite material, and it is also preferred that the states of carbon fiber bundle and single fiber are mixed.

Discontinuous carbon fibers may be in the shape of a mat such as a chopped strand mat, and the chopped strand mat and a thermoplastic resin may constitute the carbon fiber composite material. The chopped strand mat may include a carbon fiber bundle (A) in a ratio of from 20 to less than 99 Vol %, preferably from 30 to less than 90 Vol %, and particularly from 35 to 80 Vol % to a total volume of carbon fibers contained in the chopped strand mat, the carbon fiber bundle (A) may include the carbon fibers of a critical single fiber number defined by formula (a) or more, and an average number (N) of the carbon fibers in the carbon fiber bundle (A) may satisfy formula (b):

Critical single fiber number=600/D (a)

0.7×10⁴/D²<N<1×10⁵/D² (b)

wherein D is an average fiber diameter (μm) of the carbon fibers.

Discontinuous carbon fibers are preferably formed into a random mat in which the fibers are arranged two-dimensionally-randomly and isotropically and in which the fibers and a thermoplastic resin are mixed. The thermoplastic carbon fiber composite material can be formed from the random mat as described below. Specifically, carbon fiber bundle contained in the random mat also preferably satisfies the formula (a) and (b). That is, the random mat may include a carbon fiber bundle (A) in a ratio of from 20 to less than 99 Vol %, preferably from 30 to less than 90 Vol %, and particularly from 35 to 80 Vol % to a total volume of carbon fibers contained in the random mat, the carbon fiber bundle (A) may include the carbon fibers of a critical single fiber number defined by formula (a) or more, and an average number (N) of the carbon fibers in the carbon fiber bundle (A) may satisfy formula (b):

Critical single fiber number=600/D (a)

0.7×10⁴/D²<N<1×10⁵/D² (b)

wherein D is an average fiber diameter (μm) of the carbon fibers.

The thermoplastic carbon fiber composite material can be produced by, for example, methods described in WO2012/105080 pamphlet (PCT/JP2011/07314) and JP-A-2013-49208 (Japanese Patent Application No. 2011-188768). Specifically, a strand including a plurality of carbon fibers is continuously slit or split along a fiber length direction to form a plurality of narrow strands having a width of from 0.05 to 5 mm as needed, the narrows strands are continuously cut into carbon fiber bundles having an average fiber length of from 3 to 100 mm, and the cut carbon fiber bundles are opened partially by blowing a gas to the fiber bundles. The partially opened carbon fiber bundles deposited in a layer form on a breathable conveyer net or the like. Thus, a mat (chopped strand mat) of carbon fibers can be obtained. In this case, an isotropic random mat containing a thermoplastic resin can be obtained by depositing granular or short fiber-shaped thermoplastic resin on the breathable conveyer net together with carbon fibers or by supplying a molten thermoplastic resin to a mat-shaped carbon fiber layer (e.g., chopped strand mat) to penetrate the resin into the mat-shaped carbon fiber layer. In this method, by adjusting the condition of fiber opening, the carbon fiber bundles are opened partially such that the carbon fiber bundle (A) including the carbon fibers of a critical single fiber number defined by the above formula (a) or more and the carbon fiber bundle (B) including the carbon fibers of less than the critical single fiber number are mixed, to obtain an isotropic random mat in which the ratio of the carbon fiber bundle (A) to the total volume of the carbon fibers is from 20 to less than 99 Vol %, and the average number (N) of the carbon fibers in the carbon fiber bundle (A) satisfies the above formula (b).

In the above method, it is also possible to form the isotropic random mat on a non-woven fabric by arranging the non-woven fabric including a thermoplastic resin on a net conveyer, and moving the non-woven fabric together with the net conveyer.

Thus, the thermoplastic carbon fiber composite material prepared using the random mat containing the specific ratio of the carbon fiber bundles in the state that a certain number of carbon fibers are bundled has particularly good joint property to a metal member described hereinafter. Although the reason is not yet clarified, it is presumed to be due to thermal shrinkage difference between the thermoplastic carbon fiber composite material and the metal, joint area, and the surface state of the thermoplastic carbon fiber composite material.

For a UD sheet in which continuous carbon fibers are arranged in one direction, a fibrous sheet prepared by paper-making method or a random mat including discontinuous carbon fibers, and the like, each is formed into a thermoplastic carbon fiber composite material containing a thermoplastic resin as a matrix by pressuring and heating a sheet or mat of a single layer or a stacked layers in the state of containing the thermoplastic resin, melting the thermoplastic resin contained in the sheet or mat to impregnate the molten thermoplastic resin among carbon fibers. The thermoplastic resin in this case may be supplied when producing a sheet or mat of carbon fibers, and the sheet or mat may be impregnated (or mixed) with the thermoplastic resin by stacking a layer including a thermoplastic resin, and pressuring and heating the sheet or mat after the production of the sheet or mat including carbon fibers. Either thermoplastic carbon fiber composite material is not limited to a sheet shape, may be formed so as to have a cross-section of L-shape, T-shape, H-shape, U-shape and V-shape, and may have a curved surface.

As the thermoplastic carbon fiber composite material, a material prepared from pellets may be used which are obtained by steps of adjusting a molten resin to a viscosity, impregnating carbon fiber of continuous fiber with the molten resin, extruding and then cutting, and the pellets may be molded into a shaped carbon fiber composite material by an injection molding method.

### [Metal]

Examples of the metal used in the present invention specifically include metals such as iron, stainless steel, aluminum, copper, brass, nickel and zinc, and alloy thereof. It is preferred that the element constituting the metal mainly comprises iron or aluminum. The term “mainly comprises” used herein means that the element occupies 90% by weight or more in the metal. Particularly, iron such as rolled steel material for general structure (SS steel), cold-rolled steel material (SPCC steel) or high-ten material (high tensile steel), stainless steel such as SUS304 or 316, aluminum of #1000-700, and its alloy are preferably used.

As the metal joined to the thermoplastic carbon fiber composite material in the present invention, a member comprising two kinds or more of metals may be used, and a metal having metal plating on the surface thereof may be used.

The shape of the metal to be joined is not particularly limited, and can be appropriately selected in conformity with the joint member to be obtained. The shape is not limited to a plate shape only so long as a surface necessary for joint to the thermoplastic carbon fiber composite material is secured, and optional shape can be used. For example, a metal member having a cross-section of L-shape, T-shape, H-shape, U-shape and V-shape may be used, and a cylindrical metal member may be used. Furthermore, a metal member having a curved surface may be used.

### [Layer Containing Triazine Thiol Derivative]

The layer containing a triazine thiol derivative is formed on the surface to be joined of a metal, and is used for joining. The layer containing a triazine thiol derivative is not required to be formed on the entire surface to be joined of the metal, and its thickness is not particularly limited so long as adhesiveness is secured. Preferred examples of the triazine thiol derivative include dehydrated silanol-containing triazine thiol derivative to which chemical bonding to a metal can be expected, and an alkoxysilane-containing triazine thiol derivative.

The alkoxysilane-containing triazine thiol derivative is preferably at least one selected from the group consisting of compounds represented by the following general formulae (1) and (2):

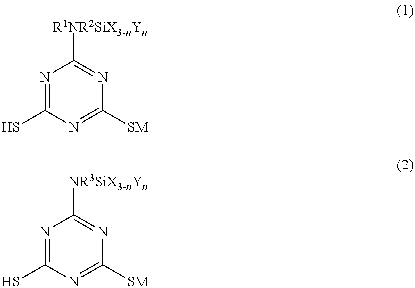

(In the above general formulae (1) and (2), R¹ is any one of H—, CH₃—, C₂H₅—, CH₂═CHCH₂—, C₄H₉—, C₆H₅— and C₆₋₁₃—. R² is any one of —CH₂CH₂—, —CH₂CH₂CH₂—, —CH₂CH₂CH₂CH₂CH₂CH₂—, —CH₂CH₂SCH₂CH₂— and —CH₂CH₂NHCH₂CH₂CH₂—. R³ is —(CH₂CH₂)₂CHOCONHCH₂CH₂CH₂— or —(CH₂CH₂)₂N—CH₂CH₂CH₂—, and in this case, N and R³ form a cyclic structure.

In the above general formulae (1) and (2), X is any one of CH₃—, C₂H₅—, n-C₃H₇—, i-C₃H₇—, n-C₄H₉—, i-C₄H₉—, t-C₄H₉— and C₆H₅—, Y is any one of CH₃O—, C₂H₅O—, n-C₃H₇O—, i-C₃H₇O—, n-C₄H₉O—, i-C₄H₉O—, t-C₄H₉O— and C₆H₅O—, n is any one of 1, 2 and 3, and M is —H or an alkali metal), and the following general formula (3):

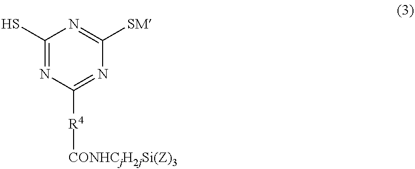

(In the above general formula (3), R⁴ is —S—, —O—, NHCH₂C₆H₄O₅—, NHC₆H₄O₅—, —NHC₆H₃(Cl)O—, —NHCH₂C₆H₃(NO₂)O—, —NHC₆H₃(NO₂)O—, —NHC₆H₃(CN)O—, —NHC₆H₂(NO₂)₂O—, —NHC₆H₃(COOCH₃)O—, —NHC₁₀H₆O—, —NHC₁₀H₅(NO₂)O—, —NHC₁₀H₄(NO₂)₂O—, —NHC₆H₄S—, —NHC₆H₃(Cl)S—, —NHCH₂C₆H₃(NO₂)S—, —NHC₆H₃(NO₂)S—, —NHC₆H₃(CN)S—, —NHC₆H₂(NO₂)₂S—, —NHC₆H₃(COOCH₃)S—, —NHC₁₀H₆S—, —NHC₁₀H₅(NO₂)S— and —NHC₁₀H₄(NO₂)₂S—, M′ is —H or an alkali metal, Z is an alkoxy group, and preferably an alkoxy group having from 1 to 4 carbon atoms, and j is an integer of from 1 to 6).

In the above general formulae (1) to (3), the alkali metal is at least one selected from the group consisting of lithium, sodium, potassium, rubidium and cesium.

Preferred examples of the triazine thiol derivative used in the present invention specifically include the following monosodium triethoxysilylpropylaminotriazine thiol that is an alkoxysilane-containing triazine thiol derivative showing excellent effect.

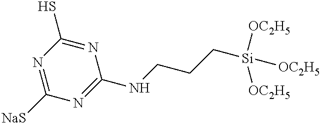

Preferred example of the method for forming the layer containing a triazine thiol derivative includes the method described in WO2009/157445, pamphlet. Specifically, a method of dipping in alkoxysilane-containing triazine thiol, water and ethanol solution, pulling out, subjecting to heat treatment, completing reaction and drying is exemplified. The layer containing a triazine thiol derivative may contain substances other than the triazine derivative in a range that the object of the present invention is not impaired.

### [Metal Compound Layer]

It is preferable that a thin metal compound layer such as a hydroxide, a carbonate, a phosphate or a sulfate may be formed between the layer containing a triazine thiol derivative and the metal, and the formation can expect further enhancement in joint strength. It is recommended, therefore, to prepare such metal compound layer on the metal surface prior to forming the layer containing triazine thiol derivative mentioned above. The method for preparing the metal compound layer on metal surface preferably includes the method described in WO2009/157445, and specifically includes a method of dipping at least metal surface, which is to be jointed, in an acid such as hydrochloric acid, sulfuric acid or phosphoric acid.

### [Thermoplastic Resin Layer]

The present invention is characterized in that the thermoplastic resin layer is provided between the thermoplastic carbon fiber composite material and the layer containing a triazine thiol derivative provided on the metal, and the thermoplastic resin layer is melted, thereby joining the metal to the carbon fiber composite material. The thermoplastic resin layer is not required to be provided on the entire surface to be joined, so long as adhesiveness is secured. The thermoplastic resin layer is arranged in a form such as a film, a woven fabric, a non-woven fabric or powder, and heat and pressure are applied to melt the thermoplastic resin, thereby joining the metal to the carbon fiber composite material.

The thermoplastic resin constituting the thermoplastic resin layer is preferably a resin that is compatible with the matrix resin of the thermoplastic carbon fiber composite material, and preferably includes the same resin as the matrix resin constituting the thermoplastic carbon fiber composite material. More preferably, the thermoplastic resin constituting the thermoplastic resin layer and the thermoplastic resin constituting the thermoplastic carbon fiber composite material are the same kind of resins. The preferred examples of the thermoplastic resin constituting the thermoplastic resin layer include the same resins as described in the thermoplastic resin constituting the thermoplastic carbon fiber composite material.

The thermoplastic resin layer has a thickness of preferably from 5 μm to 5 mm, more preferably from 20 μm to 4 mm, and still more preferably from 40 μm to 3 mm. Where the thickness of the resin layer is less than 5 μm, a resin necessary for welding becomes insufficient, and there is a case that sufficient strength is not obtained. Where the thickness of the resin layer exceeds 5 mm, moment acts on a joint surface when shear load is applied to both, and strength may be decreased as a whole. By providing the resin layer in a thickness of 5 μm or more, sufficient resin can be supplied when welding, and the carbon fiber can be prevented from contacting with the metal. As a result, prevention of electrolytic corrosion can be expected, which is preferred.

Here, with respect to the thickness of the thermoplastic resin layer, in the case where the thermoplastic resin layer is substantially constituted of a film, a sheet, a woven fabric, and the like, it means a thickness before melting of the layer. If a plurality of layers is stacked, it means a total thickness after stacking of the layers.

The joint surface between the thermoplastic carbon fiber composite material and the metal is not limited to a flat surface, and may be a curved surface or uneven surface. By using a non-woven fabric as the thermoplastic resin layer, placing the non-woven fabric on the joint surface and melting the non-woven fabric, the joint can be performed without problem even though a gap is somewhat present between the thermoplastic carbon fiber composite material and the metal that are bonded.

### <Non-Woven Fabric>

In the present invention, the thermoplastic resin layer may be formed from a non-woven fabric of a thermoplastic resin. The non-woven fabric is constituted of a thermoplastic resin that melts by heating and adheres to a metal surface. Examples of the resin include nylon (hot-melt polyamide), polycarbonate, polyester such as polyethylene terephthalate, polybutylene terephthalate, polyethylene naphthalate, polyolefin such as polyethylene and polypropylene. Of those, nylon and polypropylene are preferably used from the balance between costs and properties. The nylon (abbreviated as PA) is particularly preferably PA6, PA66, a copolymer including those as main components, and a blend of those. Those non-woven fabric-constituting resins may contain additives such as a stabilizing agent and a flame retardant, according to the need.

The non-woven fabric may be made of a continuous and/or discontinuous fiber. The fiber that is easy to melt by heating is preferred, and from this standpoint, an undrawn fiber that is not subjected to stretching nor heat treatment is appropriate. When the non-woven fabric is made of the same kind of resin as the thermoplastic resin that is a matrix of the thermoplastic carbon fiber composite material is used, the thermoplastic resin of the non-woven fabric is compatible with the matrix resin of the thermoplastic carbon fiber composite material by heating and melting as described hereinafter, and the both becomes completely unified homogeneously, which is preferable.

Non-woven fabrics produced by any method of a dry process such as an air raid method or a needle punch method, and a wet process such as a paper-making method can be used as the non-woven fabric. However, use of the non-woven fabric by a spun-bond method (including a melt-blow method, but not limited to this), including a continuous undrawn fiber excellent in costs, productivity and hot-meltability is particularly preferred.

The thermoplastic resin layer formed from the non-woven fabric in the present invention may be constituted of one non-woven fabric only, and be a layered product of a plurality of non-woven fabrics. In the case of the latter, different kinds of non-woven fabrics may be combined and stacked. This non-woven fabric is preferably provided over the entire surface on which the thermoplastic carbon fiber composite material and the metal are to be jointed. However, in the case that necessary joint strength (adhesiveness) can be secured, the non-woven fabric may locally be provided. Furthermore, the non-woven fabric can contain an appropriate amount of water, a plasticizer or the like for the purpose of making the non-woven fabric to melt easily by heating, according to the need.

The non-woven fabric used in the present invention is preferably that the total density is from 10 to 500 g/m², and the total bulk density is from 0.01 to 0.8 g/cm³. The non-woven fabric having the total density and total bulk density fallen within the above ranges has both appropriate air permeability and elasticity in the thickness direction thereof. Therefore, when the thermoplastic carbon fiber composite material and the metal are stacked in the state of intervening the non-woven fabric layer therebetween and pressurized under heating, the non-woven fabric layer is melted under almost uniform pressure, and therefore, permeation into the thermoplastic carbon fiber composite material surface and/or fine unevenness present on the metal surface become easy, thereby joint area can be secured. As a result, joint strength can be enhanced. Furthermore, the non-woven fabric has appropriate flexibility, and therefore, even in the case that the joint face is a curved surface, follow-up property to a shape becomes easy. As a result, material setting at the time of molding is easy, and the joint strength at a target site can be enhanced. Therefore, extremely excellent joint state can be achieved by using the non-woven fabric.

The “total density” and “total bulk density” used here are a density and a bulk density of the non-woven fabric constituting the thermoplastic resin layer, respectively. When the thermoplastic resin layer is constituted of single non-woven fabric, those are the density and bulk density of the non-woven fabric, and in the case that a plurality of non-woven fabrics are stacked to constitute the thermoplastic resin layer, those are the total of densities and total of bulk densities, of the non-woven fabrics stacked.

### [Welding Method]

In the method for producing a joint member of the present invention, the thermoplastic resin layer is provided between the layer containing a triazine thiol derivative on the surface of the metal and the carbon fiber composite material, and then the thermoplastic resin layer is melted, thereby joining (welding) the metal firmly to the carbon fiber composite material.

The method for melting a thermoplastic resin layer is preferably a method by heating and pressurizing. The heating method is preferably heat transfer, radiation, and the like by an external heater. The thermoplastic resin layer may be heated through the metal which is stacked on the layer. A method for heating the metal to be joined, by electromagnetic induction is extremely preferred for the reason that a joint surface to a resin can be directly heated. Other than the above, a method of heating with ultrasonic wave, laser or the like can be employed. The timing of heating the metal is preferably to match when molding the heated resin, from the standpoint that welding strength is most increased. However, on the step, it is possible to heat the metal after molding, and again pressurizing to join.

The heating temperature is preferably from a melting temperature of the thermoplastic resin constituting the thermoplastic resin layer to a decomposition temperature thereof, and more preferably from (melting temperature+15° C.) to (decomposition temperature−30° C.). The pressuring conditions are that a pressure of from 0.01 to 2 MPa, preferably from 0.02 to 1.5 MPa, and still more preferably from 0.05 to 1 MPa, is applied to the welding surface. Where the pressure is less than 0.01 MPa, good joint strength may not be obtained, and there is a case that the composite material springs back during heating, and the shape cannot be maintained, thereby decreasing material strength. On the other hand, where the pressure exceeds 2 MPa, pressurized part may crush, thereby it may be difficult to maintain the shape and material strength may be decreased. The “melting temperature” used here is a melting point of a resin constituting a thermoplastic resin layer, and is a temperature that initiates sufficient flowability when a melting point does not exist.

The thermoplastic resin layer provided between the layer containing a triazine thiol derivative and the carbon fiber composite material may be formed by previously adhering the resin layer to any one side of those. In the case of forming the thermoplastic resin layer on any one side, the thermoplastic resin layer is preferably provided by adhesion at the side of the metal surface having the layer containing a triazine thiol derivative. Furthermore, the joint member can be produced by stacking the carbon fiber composite, the thermoplastic resin layer and material on the metal having the layer containing a triazine thiol derivative attached thereto, and simultaneously thermocompression-bonding the whole.

The thermoplastic resin layer can be arranged on the surface of the metal by using the thermoplastic resin in a form such as a film, a woven fabric, a non-woven fabric or a sheet and thermocompression-bonding the same, or adhering the molten resin in small thickness by injection molding.

The temperature of the metal when contacting the molten thermoplastic resin is preferably from (melting temperature of thermoplastic resin+15° C.) to (decomposition temperature thereof−30° C.). For example, in the case where the thermoplastic resin layer is formed from PA6 (melting temperature: 220° C.), it is preferably from 235 to 300° C. The “melting temperature” used here is a melting point of a resin constituting a thermoplastic resin layer, and is a temperature that initiates sufficient flowability when a melting point does not exist. Where the temperature of the metal is lower than the range, there is a case that the resin is difficult to adapt to the surface. On the other hand, where the temperature exceeds the range, decomposition of the resin may proceed. The time for maintaining the temperature is better to be short as possible if the time for substantially joining the metal to the thermoplastic carbon fiber composite material can be secured. The joint strength between the thermoplastic resin layer and the metal is that affinity by the layer containing a triazine thiol derivative on the surface of the metal is important, and there is generally a concern that the layer containing a triazine thiol derivative modifies by high temperature. For this reason, high temperature in a long period of time is not preferred. As one example, the joint time at 275° C. is preferably from 10 seconds to 10 minutes.

Furthermore, the joint body can be produced by interposing one layer or multilayer of the thermoplastic resin layer between the joint surface of the metal having the layer containing the triazine thiol derivative and the thermoplastic carbon fiber composite material, and thermocompression-bonding the whole by pressuring and heating it at a temperature of from (melting temperature of thermoplastic resin+15° C.) to (decomposition temperature of thermoplastic resin−15° C.). In the case of stacking a plurality of thermoplastic resin layers, the layers including different kinds of thermoplastic resins can be combined and used.

### [Metal Composite Molded Body]

In the case of joining a conventional carbon fiber composite material containing a thermosetting resin as a matrix to a metal, it has been forced to use of an adhesive or the molding over a long period of time in an autoclave after inserting the metal in a prepreg. The present invention, however, uses the carbon fiber composite material containing a thermoplastic resin as a matrix, and therefore, the joining of the metal can be conducted simultaneously with a molding step such as pressing, or continuously. That is, the present invention includes a method for producing a metal composite molded body in which a carbon fiber composite material and a metal are joined, characterized in that the molding and the joining are simultaneously conducted in a mold.

A method for producing a metal composite molded body according to an embodiment of the present invention is a method in which a carbon fiber composite material containing a thermoplastic resin as a matrix, and a metal are joined, characterized in that a layer containing a triazine thiol derivative is provided on the surface of the metal, and a thermoplastic resin layer provided between the layer containing a triazine thiol derivative and the carbon fiber composite material is melted, thereby simultaneously or continuously conducting the joining and molding of the metal and the carbon fiber composite material. The term “continuously conducting the joining and molding of the metal and the carbon fiber composite material” includes not only an embodiment that after joining the metal to the carbon fiber composite material, the molding is continuously conducted, but also an embodiment that after molding the carbon fiber composite material into a desired shape, the metal is continuously joined.

According to the present invention, the molding and joining in the production of the metal composite molded body can be conducted in a short period of time. Therefore, the method of the present invention is an industrially superior method as compared with the case of using the conventional carbon fiber composite material containing a thermosetting resin as a matrix.

### [Joint Member]

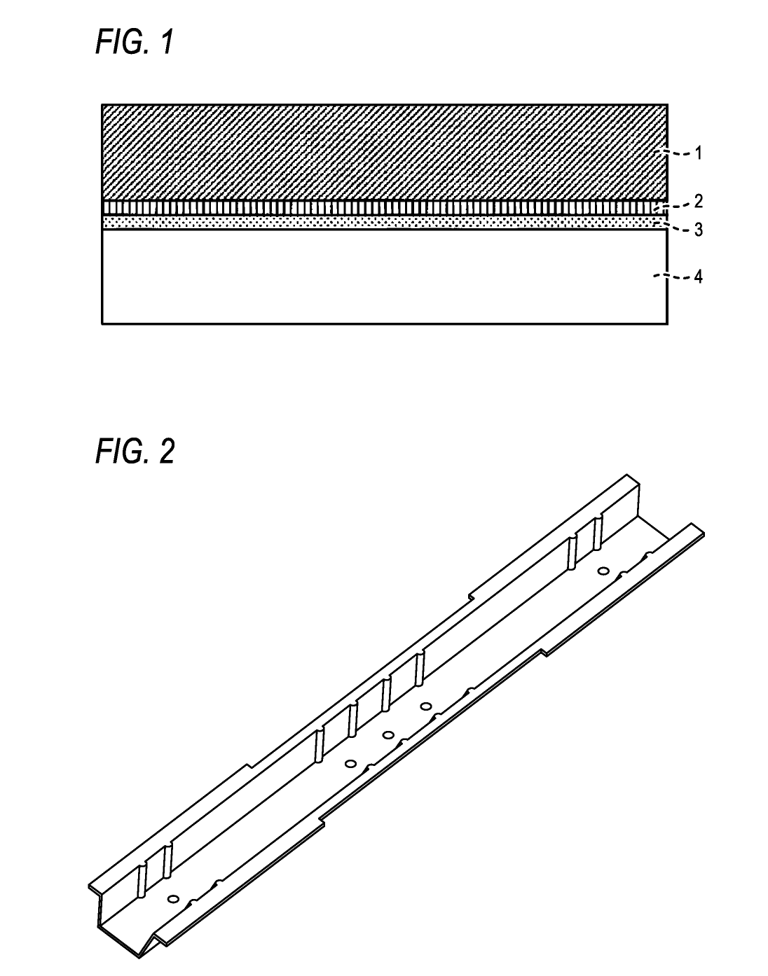

The joint member comprising a carbon fiber composite material and a metal that are strongly joined is obtained. FIG. 1 shows one embodiment (cross section view) of the joint member obtained by the present invention. As shown in FIG. 1, the joint member of the present invention comprises a thermoplastic carbon fiber composite material 1 and a metal 4, which are adhered and joined together through the intermediate layers, a molten thermoplastic resin layer 2 and a triazine thiol derivative layer 3, between the composite material 1 and the metal 4. A thin metal compound layer (not shown) may exist between the surface of the metal 4 and a triazine thiol derivative layer 3.

The joint member obtained by the present invention has a joint strength of 5 MPa or more, and the upper limit of the joint strength is substantially about 50 MPa. The joint strength can be evaluated by a tensile test mentioned below.

The joint member and the metal composite molded body, obtained in the present invention are suitably used as a structural member requiring strength. Example of the structural member includes a part constituting a moving vehicle such an automobile. The number of a joint part of the joint member is not limited, and can be optionally selected depending on single lap or double lap, and depending on joint environment. The double lap is that the joint area becomes two times, and therefore, the joint strength becomes two times.

### EXAMPLES

The present invention is specifically described below on the basis of examples, but the invention is not limited to those.

Conditions of the measurement of physical properties and the evaluation in each example and comparative example are as follows.

### 1) Joint Strength

Five joint members as described in each example were prepared, and a value of a tensile strength obtained by conducting a tensile test in a given rate by a universal tester INSTRON (registered trademark) 5587 was defined as a value of joint strength of the joint member. “The average joint strength” described in the following examples means the average value of the joint strength determined as to the five samples obtained in each example.

### 2) Analysis of Fiber Bundle of Composite Material

The analysis of a fiber bundle of the composite material obtained by Reference Examples 2B to 2E was carried out according to the method described in WO2012/105080 pamphlet.

### Reference Example 1

### Production of Carbon Fiber Composite Material of Continuous Fiber 0° and 90° Alternate Stacking Materials

Strands of carbon fibers (“TENAX”™ STS40-24KS (fiber diameter: 7 μm, tensile strength: 4,000 MPa), manufactured by Toho Tenax Co., Ltd.) and nylon 6 films (“EMBLEM”™ ON, 25 μm thick, manufactured by Unitika Ltd.) were sequentially stacked to stack 64 layers (carbon fiber: 64 layers, nylon: 65 layers) such that layers having a fiber direction of 0° and layers having a fiber direction of 90° were arranged alternately, and the resulting assembly was compressed under heating at 260° C. under a pressure of 2 MPa for 20 minutes. Thus, a carbon fiber composite material having 0° and 90° alternate fibers, symmetric stacking, carbon fiber volume content: 47% (content of carbon fibers in mass basis: 57%) and a thickness of 2 mm was prepared.

### Reference Example 2A

### Production of Flat Plate Carbon Fiber Composite Material (A)

Carbon fibers (“TENAX”™ STS40, average fiber diameter: 7 μm, manufactured by Toho Tenax Co., Ltd.) cut into an average fiber length of 16 mm were randomly arranged such that an average density is 540 g/m², and were sandwiched among 10 cloths of KE 435-POG (nylon 6), manufactured by Unitika Ltd. The resulting assembly was pressed at 260° C. under 2.5 MPa to prepare a flat plate carbon fiber composite material having 1400 mm×700 mm, a carbon fiber volume content of 35% (content of carbon fibers on the basis of mass: 45%) and a thickness of 2 mm.

### Reference Example 2B

### Production of Flat Plate Carbon Fiber Composite Material (B)

Carbon fibers (“TENAX”™ STS40, average fiber diameter: 7 μm, manufactured by Toho Tenax Co., Ltd.) were cut into an average fiber length of 20 mm and were formed into a carbon fiber sheet in a random arrangement state such that an average density is 540 g/m². The carbon fiber sheet were sandwiched among cloths of KE 435-POG (nylon 6), manufactured by Unitika Ltd. so as to form an assembly by repeatedly stacking of carbon fiber sheet/nylon 6 cloth. The resulting assembly was pressed at a temperature of 260° C. under a pressure of 2.5 MPa to prepare a flat plate carbon fiber composite material (B) having a carbon fiber volume content of 35% (content of carbon fibers on the basis of mass: 45%) and a thickness of 2 mm.

### Reference Example 2C

### Production of Flat Plate Carbon Fiber Composite Material (C)

A strand of “TENAX”™ STS40-24KS (fiber diameter: 7 μm, tensile strength: 4,000 MPa), manufactured by Toho Tenax Co., Ltd. was used as a carbon fiber, and cut into a given length. The carbon fibers cut were deposited on a net conveyer equipped with a lower suction apparatus through an opening apparatus (gas spray nozzle) and a flexible transport piping, thereby preparing chopped strand mats having different average fiber length, degree of opening, and the like. The chopped strand mats obtained were sandwiched among cloths of KE 435-POG (nylon 6), manufactured by Unitika Ltd in the same manner as in Reference Example 2B. The resulting assembly was pressed at a temperature of 260° C. under a pressure of 2.5 MPa to prepare two kinds (Sample 1 and Sample 2) of flat plate carbon fiber composite materials (thickness: 2 mm) having different carbon fiber volume content as shown in Table 1 below.

### Reference Example 2D

### Production of Flat Plate Carbon Fiber Composite Material (I)

A carbon fiber composite material was prepared according to the method described in WO2012/105080 pamphlet. Specifically, a strand of carbon fibers (“TENAX”™ STS40-24KS (fiber diameter: 7 μm, tensile strength: 4,000 MPa), manufactured by Toho Tenax Co., Ltd.) was cut into a given length. The carbon fibers cut were deposited on a fixing net equipped with a lower suction apparatus through an opening apparatus (air spray nozzle) and a flexible transport piping, thereby preparing two kinds of chopped strand mats having different average fiber length and degree of opening. The chopped strand mats obtained were sandwiched among cloths of KE 435-POG (nylon 6), manufactured by Unitika Ltd., respectively. The resulting assembly was pressed at a temperature of 260° C. under a pressure of 2.5 MPa to form a flat plate shape having a thickness of 2 mm. Thus, two kinds (Sample 3 and Sample 4) of flat plate carbon fiber composite materials (I) having different carbon fiber volume content (Vf) as shown in Table 2 were prepared.

### Reference Example 2E

### Production of Flat Plate Carbon Fiber Composite Material (II) Using Random Mat

A carbon fiber composite material was prepared according to the method described in JP-A-2013-49208. In this example, a strand of carbon fibers (“TENAX”™ STS40-24KS (fiber diameter: 7 μm, tensile strength: 4,000 MPa), manufactured by Toho Tenax Co., Ltd.) was used. The carbon fiber strand was slit into a width of 0.8 mm using a vertical slit apparatus, and then cut into a fiber length of 20 mm. A rotary cutter having a spiral knife arranged on the surface thereof using cemented carbide was used as the cutting apparatus.

The strand passing through the cutter was introduced in a flexible transport piping arranged just below the rotary cutter, and then introduced in an fiber opening apparatus (air spray nozzle) arranged at the lower end of the transport piping. In order to prepare the fiber opening device, nipples made of SUS304 having different diameters were welded to prepare a double pipe. Small holes were provided on an inner pipe of the double pipe. Compressed air was sent between the inner pipe and the outer pipe of the fiber opening device by a compressor. In this case, blowout velocity of the air from small holes was 450 msec. A tapered pipe in which a diameter is increased toward the lower side was welded to the lower end of the double pipe such that the carbon fibers cut move to the lower side together with air flow in the tapered pipe.

Particles of nylon (polyamide 6) resin “A1030”, manufactured by Unitika Ltd., was supplied into the tapered pipe from the holes provided on the side surface of the pipe. A breathable net conveyer (hereinafter referred to as “fixing net”) that moves in a certain direction was arranged at the lower side of the outlet of the tapered pipe. Suction was conducted from the lower side of the fixing net by a blower, and while reciprocating the tapered pipe in a width direction of the fixing net moving in a constant rate, a mixture of the cut carbon fibers and the nylon resin particles discharged together with air flow from the tip of the tapered pipe and they were deposited on the fixing net in a mat shape. In this case, the amount of the carbon fibers supplied was set to 212 g/min, the amount of the matrix resin supplied was set to 320 g/min. As a result, a random mat in which the carbon fibers and the thermoplastic resin were mixed without unevenness was formed on the fixing net. The density of carbon fibers of the random mat was 265 g/m².

As a result of examining a ratio of the carbon fiber bundle (A) and an average number of carbon fibers in the carbon fiber bundle (A) in the random mat obtained, the critical single fiber number defined by the above formula (a) was 86. The ratio of the carbon fiber bundle (A) to the total volume of the carbon fibers in the mat was 35 Vol %, and the average number (N) of carbon fibers in the carbon fiber bundle (A) was 240. The nylon resin particles were uniformly dispersed in the carbon fibers in the state of substantially free of unevenness.

Four random mats obtained were laminated, placed in a mold, and press-shaped at a temperature of 300° C. under a pressure of 1.0 MPa for a heating time of 3 minutes to obtain a plate-shaped composite material (II) having a thickness of 2.0 mm and carbon fiber volume content of 30% (content of carbon fibers on the basis of mass: 40%).

As a result of measuring modulus of elasticity in tension in 0° and 90° directions of the carbon fiber composite material (II) obtained, the ratio (Eδ) of modulus of elasticity was 1.03, fiber orientation was not substantially observed, and a shaped plate in which isotropy was maintained was obtained. Furthermore, the shaped plate was heated at 500° C. for about 1 hour in a furnace to remove the resin, and the ratio of the carbon fiber bundle (A) and the average number (N) of carbon fibers in the carbon fiber bundle (A) were examined. As a result, the difference to the above measurement results of the random mat was not observed.

### Reference Example 3

### Production of Nylon 6 Non-Woven Fabric

Nylon 6 non-woven fabric was produced by a melt-blow method using “NOVAMID”™ 1010C2, manufactured by DMS Japan Engineering Plastics Corporation as a raw material. The melt-blow method employed here is a method for producing a non-woven fabric by extruding a molten polymer from a plurality of orifices, injecting a high speed gas from an injection gas port provided adjacent to the orifices to form the ejected molten polymer into fine fibers, and then collecting fiber flow on a conveyer net that is a collector. The nylon 6 non-woven fabric obtained had an average fiber diameter of 5 μm, an average density per one non-woven fabric of 20 g/m², an average bulk density of 0.1 g/cm³, and an average thickness of 0.2 mm.

### Reference Example 4

### Metal Surface Treatment

A metal sheet having a length of 100 mm, a width of 25 mm and a thickness of 1.6 mm was degreased in a sodium hydroxide aqueous solution having a concentration of 15.0 g/L at a temperature of 60° C. for 60 seconds. The metal sheet was then washed with water for 60 seconds and dried in an oven at 80° C. for 30 minutes. The metal sheet was dipped in a phosphoric acid aqueous solution (90% or more of components other than water is phosphoric acid) having a concentration of from 30 to 50 g/L for 300 seconds, and then washed with hot water (60° C.) for 60 seconds and washed with water for 60 seconds, to form a metal compound coating film comprising a metal phosphate and a hydroxide as main components on the surface of the metal sheet. The metal sheet having the metal compound coating film was dipped in an ethanol/water (volume ratio: 95/5) of monosodium triethoxysilylpropylaminotriazine thiol having a concentration of 0.7 g/L at room temperature for 30 minutes. The metal sheet was heat-treated in an oven at 160° C. for 10 minutes. The metal sheet was dipped in an acetone solution containing N,N′-m-phenylenedimaleimide having a concentration of 1.0 g/L and dicumyl peroxide having a concentration of 2 g/L at room temperature for 10 minutes, and heat-treated in an oven at 150° C. for 10 minutes. An ethanol solution of dicumyl peroxide having a concentration of 2 g/L was sprayed to the entire surface of the metal sheet at room temperature, and air-dried to provide a triazine thiol derivative layer over the entire surface of the metal sheet.

### Example 1

The metal surface treatment described in Reference Example 4 was applied to both surfaces of SPCC (cold-reduced carbon steel sheet) having a length of 100 mm, a width of 25 mm and a thickness of 1.6 mm, and two nylon 6 films (“EMBLEM”™ ON, 25 μm thick, melting point: 225° C., manufactured by Unitika Ltd) were provided on both surfaces thereof. The SPCC sheet was heated to 250° C. by electromagnetic induction heating, and then immediately cooled to ordinary temperature. The nylon films were melted and closely attached, and then solidified to form a layer of nylon 6 on the SPCC surface. The flat carbon fiber composite material (A) obtained in Reference Example 2A was cut into a length of 100 mm and a width of 25 mm, stacked on the SPCC sheet having the nylon layer in a range of 25 mm×25 mm by single lap, and pressurized under heating at 250° C. under 0.2 MPa for 5 minutes using a mold to prepare a joint member between the thermoplastic carbon fiber composite material and the SPCC sheet. Five joint members were prepared, and subjected to a tensile test in a rate of 1 mm/min by a universal tester INSTRON 5578. As a result, the average joint strength was 12 MPa.

### Example 2

The metal surface treatment described in Reference Example 4 was applied to both surfaces of a 590 MPa category high tensile steel having a length of 100 mm, a width of 25 mm and a thickness of 1.6 mm, two nylon 6 films (“EMBLEM”™ ON, 25 μm thick, manufactured by Unitika Ltd) were provided on both surfaces thereof. The high tensile steel was heated to 250° C. by electromagnetic induction heating, and then immediately cooled to ordinary temperature. The nylon films were melted, closely attached and solidified to form a layer of nylon 6 on the high tensile steel surface. The flat carbon fiber composite material (A) obtained in Reference Example 2A was cut into a length of 100 mm and a width of 25 mm, stacked on the high tensile steel having the nylon layer in a range of 25 mm×25 mm by single lap, the thermoplastic carbon fiber composite material was heated at 250° C., and the high tensile steel was heated to 140° C., followed by pressuring under heating under 0.2 MPa for 1 minute using a mold. Subsequently, the high tensile steel in the material lapped was heated to 250° C. by electromagnetic induction heating, and pressurized under heating under 0.2 MPa for 1 minute to prepare a joint member between the thermoplastic carbon fiber composite material and the high tensile steel. Five joint members were prepared, and subjected to a tensile test in a rate of 1 mm/min by a universal tester INSTRON 5578. As a result, the average joint strength was 17 MPa.

### Example 3

Two nylon 6 films (“EMBLEM”™ ON, 25 μm thick) were provided on both surfaces of the SPCC sheet having a length of 100 mm, a width of 25 mm and a thickness of 1.6 mm, which was subjected to the metal surface treatment in the same step as in Example 1. The carbon fiber composite material obtained in Reference Example 1 was cut into a length of 100 mm and a width of 25 mm, was heated to 250° C., stacked on the SPCC sheet having the nylon 6 layer in a range of 25 mm×25 mm by single lap, and pressurized under heating together with the SPCC sheet previously heated to 250° C. by electromagnetic induction heating under a pressure of 0.2 MPa for 5 minutes using a mold to prepare a joint member between the thermoplastic carbon fiber composite material and the SPCC. Five joint members were prepared, and subjected to a tensile test in a rate of 1 mm/min by a universal tester INSTRON 5578. As a result, the average joint strength was 7.4 MPa.

### Example 4

A layer of nylon 6 was formed on the surface of an aluminum sheet in the same manner as in Example 1, except that 5052 aluminum sheet having a thickness of 1 mm was used in place of the SPCC sheet. The flat carbon fiber composite material (A) obtained in Reference Example 2A was cut into a length of 100 mm and a width of 25 mm, and stacked on the aluminum steel having the nylon layer in a range of 25 mm×25 mm by single lap, followed by pressuring under heating at 250° C. under a pressure of 0.2 MPa for 5 minutes using a mold, thereby preparing a joint member between the thermoplastic carbon fiber composite material and the 5052 aluminum sheet. Five joint members were prepared, and subjected to a tensile test in a rate of 1 mm/min by a universal tester INSTRON 5578. As a result, the aluminum sheet part was broken. Calculating from breaking strength of the aluminum sheet, it was seen that the average joint strength was 7.1 MPa or more.

### Comparative Example 1

The same operation as in Example 1 was conducted, except that the nylon 6 layer was not provided on the SPCC sheet having a length of 100 mm, a width of 25 mm and a thickness of 1.6 which was subjected to the metal surface treatment in Reference Example 4, and in place of the carbon fiber composite material (A) obtained in Reference Example 2A, a nylon 6 piece having the same size was joined. However, as a result that it was tried to measure joint strength of the joint member obtained, the nylon 6 piece was broken off.

### Example 5

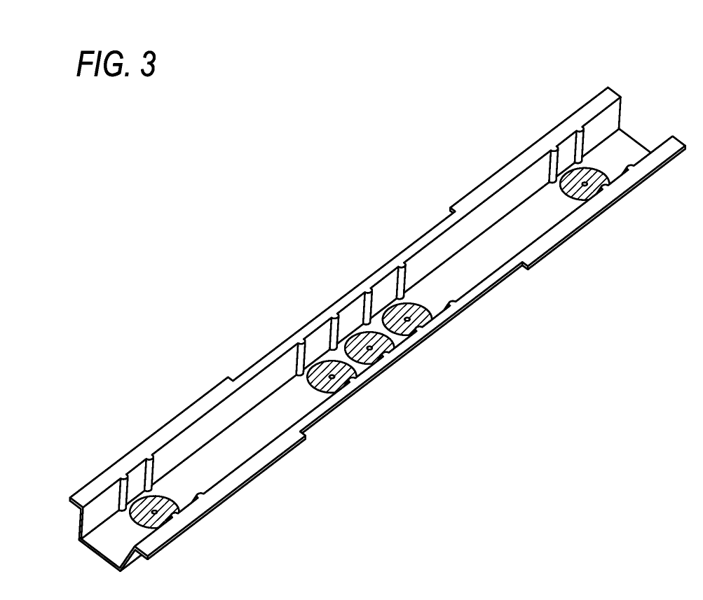

The carbon fiber composite material obtained in Reference Example 1 was heated to 250° C., and pressed under a pressure of 20 MPa using a mold at 140° C. to obtain a nearly U-shaped molded body of the carbon fiber composite material having a length of 1,200 mm, a width of 150 mm and a height of 50 mm as shown in FIG. 2. Five holes having a diameter of 10 mm were formed in the molded body as shown in FIG. 2. A disk-shaped SPCC sheet having a diameter of 100 mm and a thickness of 1.6 mm which has a hole having a diameter of 10 mm at the center thereof was subjected to the metal surface treatment in the same steps as in Example 1. The SPCC sheet was placed on each of five holes through two nylon 6 films (“EMBLEM”™ ON, 25 μm thick, manufactured by Unitika Ltd) having the same size. The resulting assembly was heated to 250° C. by electromagnetic induction heating, and the SPCC sheet was pressurized until reaching about 100° C. by a force of 20 kgf (196N), thereby joining to the molded body. Thus, a metal composite molded body was obtained. The metal composite molded body can be used as a part of a seat rail, and its shape is shown in FIG. 3.

### Example 6

The temperature of a cold rolled steel sheet (SPCC) having been subjected to surface treatment according to Reference Example 4 and having a length of 100 mm, a width of 25 mm and a thickness of 1.6 mm was risen to 240° C., and two nylon 6 woven fabrics by a melt-blow method obtained in Reference Example 3 were stacked on the upper surface of the SPCC. The carbon fiber composite material obtained in Reference Example 1 was cut into a length of 100 mm and a width of 25 mm, and was subjected to drying treatment at 80° C. for 5 hours. The composite materials were piled in a range of 25 mm×25 mm in single-lap such that the nylon 6 non-woven fabric was arranged between the composite material (I) and SPCC, and the resulting assembly was pressurized under heating at a temperature of 240° C. under a pressure of 0.5 MPa for 1 minute by a press molding machine. Thus, a plate-like joint membrane of the composite material and SPCC was prepared. Five joint materials were prepared, and subjected to a tensile test in a rate of 2 mm/min by a universal tester INSTRON 5578. As a result, the average joint strength measured by the tensile test was 15 MPa.

### Example 7

Five joint members were prepared by carrying out the same operation as in Example 6, except that the carbon fiber composite material (B) obtained in Reference Example 2B was used as the carbon fiber composite material. The joint members obtained were subjected to a tensile test in a rate of 2 mm/min by a universal tester INSTRON 5587. As a result, the average joint strength was 14 MPa.

### Example 8

Five joint members were prepared by carrying out the same operation as in Example 6, except that two kinds (Sample 1 and Sample 2) of the composite materials (C) obtained in Reference Example 2C were used as the carbon fiber composite material, respectively. Each joint member obtained was subjected to a tensile test in a rate of 2 mm/min by a universal tester INSTRON 5587. As a result, the average joint strength of each joint member was as shown in Table 1.

TABLE 1

| Target good | Measurement item | Sample 1 | Sample 2 |
|---|---|---|---|
| Carbon fiber | Average fiber length (mm) | 20 | 25 |
| composite | Critical single fiber number | 86 | 86 |
| material | Ratio of carbon | 35 | 30 |
| | fiber bundle (A) (Vol %) | | |
| | Average number of fibers (N) | 240 | 250 |
| | Carbon fiber volume content | 35 | 40 |
| | (Vol %) | | |
| Joint body | Average joint | 15 | 14 |
| with metal | strength (MPa) | | |
| plate | | | |

### Example 9

A cold rolled steel sheet (SPCC) having a length of 100 mm, a width of 25 min and a thickness of 1.6 mm was treated with the method of Reference Example 4, and the temperature thereof was then risen to 240° C. Two nylon 6 films (“EMBLEM”™ ON, 25 μm thick, manufactured by Unitika Ltd.) were placed on the upper surface of the SPCC.

On the other hand, two kinds (Sample 3 and Sample 4) of the carbon fiber composite materials (I) shown in Table 2 obtained in Reference Example 2D were cut into a length of 100 mm and a width of 25 mm, subjected to drying treatment at 80° C. for 5 hours, and overlapped with SPCC and nylon 6 film in a range of 25 mm×25 mm in single-lap. While maintaining the state, the resulting assembly was pressure-treated under heating at a temperature of 240° C. under a pressure of 0.5 MPa for 1 hour with a press molding machine. Thus, a joint member of the carbon fiber composite material and SPCC was prepared. Five joint sheets were prepared, and subjected to a tensile test in a rate of 2 mm/min by a universal tensile tester INSTRON 5587. As a result, the average joint strength of each joint member was as shown in Table 2.

TABLE 2

| Target good | Measurement item | Sample 3 | Sample 4 |
|---|---|---|---|
| Carbon fiber | Average fiber length (mm) | 20 | 25 |
| composite | Critical single fiber number | 86 | 86 |
| Material | Ratio of carbon | 35 | 30 |
| | fiber bundle (A) (Vol %) | | |
| | Average number of fibers (N) | 240 | 250 |
| | Carbon fiber volume content | 35 | 40 |
| | (Vol %) | | |
| Joint member | Average joint | 16 | 15 |
| | strength (MPa) | | |

### Example 10

A nylon 6 film layer was provided on the SPCC plate having been subjected to the metal surface treatment of Reference Example 3 and having a length of 100 mm, a width of 25 mm and a thickness of 1.6 mm in the same manner as in Example 9, and the same test was conducted using the carbon fiber composite material (II) obtained in Reference Example 2E in place of the carbon fiber composite material (I). The thermoplastic composite material-metal plate joint member obtained was subjected to a tensile test in a rate of 2 mm/min by a universal tester INSTRON 5587. As a result, the average joint strength was 15 MPa.

### Example 11

The same test as in Example 9 was conducted using two melt-blow non-woven fabrics of nylon 6 obtained in Reference Example 3 in place of the nylon 6 film in Sample 3 of Example 9. The thermoplastic composite material-metal plate joint member obtained was subjected to a tensile test in a rate of 2 mm/min by a universal tester INSTRON 5587. As a result, the average joint strength was 14 MPa.

### INDUSTRIAL APPLICABILITY

The joint member of the present invention has excellent joint strength, and can be used in various uses such as parts constituting a moving vehicle such as automobiles, aircrafts, railroad vehicles and ships, and structure members such as furniture, materials of sporting goods and building materials, cases of electric and electronic equipments, and structure members of various machinery and appliances.

What is claimed is:

1. A method for producing a joint member between a carbon fiber composite material containing a thermoplastic resin as a matrix and a metal, the method comprising:
forming a layer containing a triazine thiol derivative on a surface of the metal;
providing a thermoplastic resin layer between the layer containing the triazine thiol derivative and the carbon fiber composite material; and
melting the thermoplastic resin layer to join the metal to the carbon fiber composite material.

2. The method for producing a joint member according to claim 1, wherein the metal is heated by means of electromagnetic induction to perform the melting of the thermoplastic resin layer.

3. The method for producing a joint member according to claim 1, wherein the thermoplastic resin layer has a thickness of from 5 μm to 5 mm.

4. The method for producing a joint member according to claim 1, wherein an element constituting the metal mainly comprises iron or aluminum.

5. The method for producing a joint member according to claim 1, wherein an amount of the thermoplastic resin present in the carbon fiber composite material is from 50 to 1,000 parts by weight per 100 parts by weight of a carbon fiber.

6. The method for producing a joint member according to claim 1, wherein in the providing of the thermoplastic resin layer between the layer containing the triazine thiol derivative and the carbon fiber composite material, the thermoplastic resin layer is provided on the layer containing the triazine thiol derivative formed on the surface of the metal.

7. The method for producing a joint member according to claim 1, wherein the thermoplastic resin constituting the carbon fiber composite material is at least one selected from the group consisting of polyamide, polyester, polypropylene, polycarbonate and polyphenylene sulfide.

8. The method for producing a joint member according to claim 1, wherein a thermoplastic resin constituting the thermoplastic resin layer is the same kind of resin as the thermoplastic resin constituting the carbon fiber composite material.

9. The method for producing a joint member according to claim 1, wherein the thermoplastic resin layer is formed from a non-woven fabric comprising a thermoplastic resin.

10. The method for producing a joint member according to claim 9, wherein the thermoplastic resin constituting the non-woven fabric is the same kind of resin as the thermoplastic resin constituting the carbon fiber composite material.

11. The method for producing a joint member according to claim 1, wherein a carbon fiber in the carbon fiber composite material has an average fiber length of from 3 to 100 mm, and an amount of the thermoplastic resin present in the carbon fiber composite material is from 50 to 1,000 parts by weight per 100 parts by weight of the carbon fiber.

12. The method for producing a joint member according to claim 11, wherein the carbon fiber composite material comprises a chopped strand mat of carbon fibers and a thermoplastic resin, and
wherein the chopped strand mat comprises a carbon fiber bundle (A) in a ratio of 20 Vol % or more and less than 99 Vol % to a total volume of the carbon fibers, the carbon fiber bundle (A) includes carbon fibers of a critical single fiber number defined by formula (a) or more, and an average number (N) of the carbon fibers in the carbon fiber bundle (A) satisfies formula (b):
Critical single fiber number=600/D (a)
0.7×10⁴/D²<N<1×10⁵/D² (b)
wherein D is an average fiber diameter (μm) of the carbon fibers.

13. The method for producing a joint member according to claim 11, wherein a thermoplastic resin constituting the thermoplastic resin layer is the same kind of resin as the thermoplastic resin constituting the carbon fiber composite material.

14. A joint member comprising a thermoplastic carbon fiber composite material and a metal that are joined in joint strength of 5 MPa or more, obtained by the method described of claim 1.

15. A joint member comprising: a carbon fiber composite material; a molten thermoplastic resin layer; a layer containing a triazine thiol derivative; and a metal, wherein the carbon fiber composite material containing a thermoplastic resin as a matrix, and the carbon fiber composite material and the metal are joined by the molten thermoplastic resin layer in joint strength of 5 MPa or more.

16. A method for producing a metal composite molded body comprising a carbon fiber composite material containing a thermoplastic resin as a matrix and a metal, that are joined, the method comprising:
forming a layer containing a triazine thiol derivative on the surface of the metal;
providing a thermoplastic resin layer between the layer containing the triazine thiol derivative and the carbon fiber composite material; and
melting the thermoplastic layer to joint between the metal and the carbon fiber composite material and simultaneously or continuously mold a metal composite molded body into a predetermined form.
